(19) United States
(12) Patent Application Publication
(10) Pub. No.: US 2010/0243137 A1
(43) Pub. Date: Sep. 30, 2010

(54) FORMING PROCESS OF SHEET MATERIALS, IN PARTICULAR METAL PLATES

(76) Inventor: Manrico Del Mastro, Numana (IT)

Correspondence Address: Hodes Pessin & Katz, 901 Dulaney Valley Road, Suite 400, Towson, MD, 21204, US

(21) Appl. No.: 12/734,979

(22) PCT Filed: May 18, 2008
(86) PCT No.: PCT/IT2008/000748

§ 371 Date: Jun. 4, 2010

(30) Foreign Application Priority Data
Dec. 6, 2007 (IT) AN2007U00028

(51) Int. Cl. B29C 70/34

(52) U.S. Cl. 156/219

(57) ABSTRACT

A forming process of sheet materials that comprises the following phases is disclosed:—application of a layer of glue (4) that expands in contact with air on a base support (2) of a die (1),—positioning of sheet material (6) on the layer of glue (4),—closing of the die (1) by means of a matrix (3) provided with at least one cavity (31, 31′), for a time sufficient for the glue (4) to expand, in such a way that the shape of the matrix (3) is formed on the sheet material (6), and—opening of die and removal of formed part.

The present patent application for industrial invention relates to a forming process of sheet materials, in particular metal plates. The process of the invention is also extended to non-metal sheet materials, such as plastic sheets, of any composition, such as polymers, methacrylate, PVC, polyethylene and similar materials, and also natural and synthetic leather, wood and wood veneer, fabrics, paper and similar materials.

As it is known, the forming process of metal sheets provides for positioning the plate in a forming press composed of two die halves. The first die half, defined as matrix, has a plurality of cavities; the second die half, defined as male die holder, has a plurality of protruding parts (males) designed to be inserted in the cavities of the matrix in order to deform and shape the plate positioned between the two die halves. The two die halves are moved by means of a suitable mechanism that is electrically, hydraulically or pneumatically actuated.

The said forming process is rather complicated and expensive, due to the constructive complexity of the male die holder that must be provided with a plurality of males in register with the cavities of the matrix and the actuation mechanism of the dies, together with the electrical or hydraulic system that must guarantee pressure to deform the plate positioned between the two die halves.

The purpose of the present invention is to eliminate the drawbacks of the technique by providing a forming process of sheet materials, in particular metal plates, which is practical, versatile, inexpensive and easy to produce.

This purpose is achieved by the present invention, whose features are claimed in the independent claim 1.

Advantageous embodiments of the invention are disclosed in the dependent claims.

The forming process of sheet materials according to the present invention comprises the following phases:
application of a layer of glue that expands in contact with air on a die base support,
positioning of sheet material on the layer of glue,
pressure closing of the die by means of a matrix provided with at least one cavity, for a time sufficient for glue expansion, in such a way that the shape of the matrix is formed on the sheet material, and
opening of die and extraction of formed part.

The advantages of the process of the invention are evident, since it allows for saving on the movement system of dies and on the mechanical energy that is necessary to move them. Moreover, the process of the invention also allows for saving on the structure and materials of the die. In fact, the male die holder is not necessary and inexpensive materials, such as wood, PVC and similar materials can be used to manufacture the base support and matrix of the die.

Moreover, the base support may be part of the final product. In such a case, non-rigid products, such as leather, paper, fabric, non-woven fabric, plastic film and similar products, can be used.

Another advantage of the system of the present invention consists in that the matrix may have notches with any shape; in fact, forming is obtained from the plastic deformation (expansion) of the glue regardless of the configuration of the matrix.

Additional characteristics of the invention will appear more evident from the following detailed description, which refers to merely illustrative, not limiting embodiments, illustrated in the enclosed drawings, wherein:

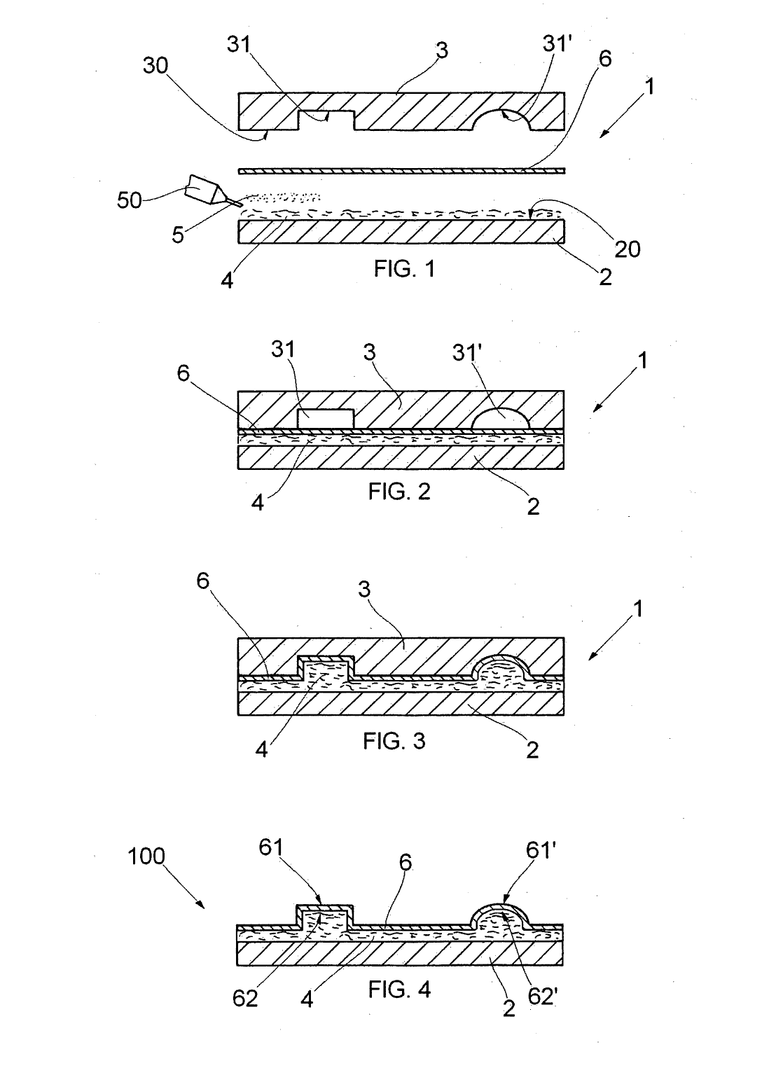

FIGS. 1-3 are three diagrammatic cross-sectional views that illustrate the three phases of the forming process of the invention, respectively; and

FIG. 4 is a cross-sectional view of a multi-layer panel formed with the process of the invention;

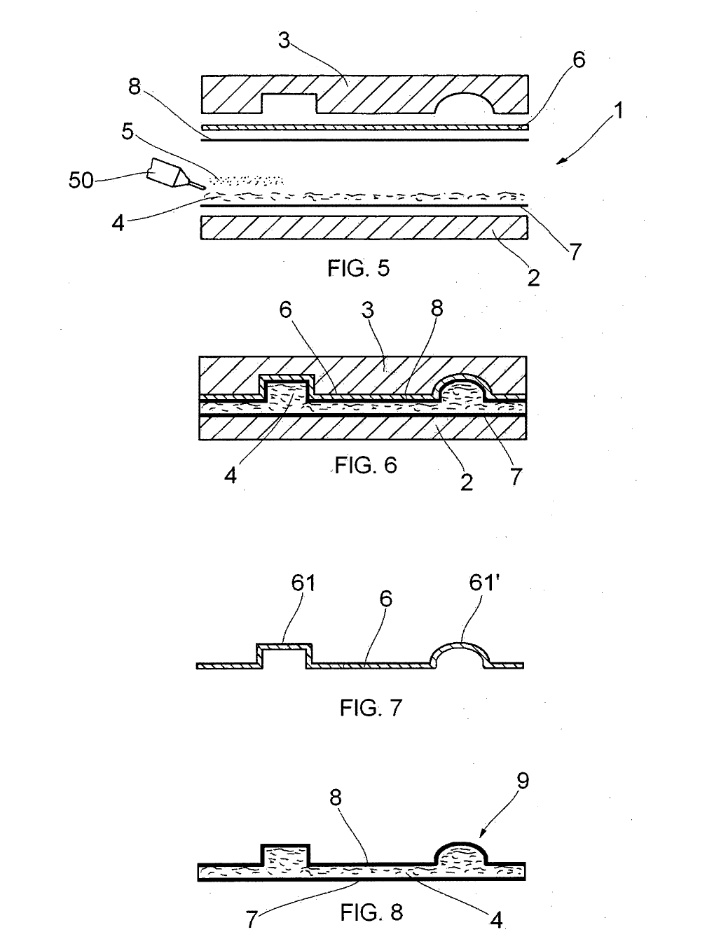

FIGS. 5 and 6 are two diagrammatic cross-sectional views that illustrate two phases of a second embodiment of the forming process of the present invention, respectively;

FIG. 7 is a cross-sectional view of a metal plate formed with the process of FIGS. 5 and 6; and

FIG. 8 is a cross-sectional view of the reject item obtained with the process of FIGS. 5 and 6.

With reference to FIG. 1, a die generally identified with numeral (1) is described.

The die (1) comprises a base support (2) and a female die half or matrix (3). The matrix (3) has a surface (30) in which at least one forming cavity (31, 31′) is obtained. The example of the figure shows, by way of illustration only, a first cavity (31) with rectangular section and a second cavity (31) with semicircular section. The support (2) has a flat surface (20) facing the forming surface (30) of the matrix (3).

Glue (4) is applied on the flat surface (20) of the base support (2) and expanded by chemical reaction in contact with air. The glue (4) may be applied with a spatula to obtain a uniform layer. Preferably, the layer of glue (4) must be sufficiently thin to avoid the generation of internal portions of glue that are not able to dry, not being in contact with air. By way of illustration, the layer of glue (4) must have a uniform thickness lower than 10 mm.

Since the drying time of the glue is inversely proportional to the humidity of the air, water spray (5) can be sprayed on the glue (4) with a spraying nozzle (50) to accelerate the forming process.

The glue (4) that is preferably used is a monocomponent polyurethane-based adhesive with viscosity of approximately 70,000 cps and specific gravity of approximately 1.4 g/m³. In particular, a tissotropic polyurethane-based adhesive may be used, being obtained from reticulated polysocyanate resins.

This type of adhesive is largely used in the building sector for its filling effect and also because it ensures weather-proof gluing. By way of illustration, adhesives that are normally found on the market with the following brands can be used: Kostrufiss® by Prochimica, Ottocoll® Rapid by Otto Chemie and CONSTREDIL™ by Saratoga.

With reference to FIG. 2, after applying the glue (4), a plate (6) to be formed is positioned on the layer of glue (4) and the die (1) is closed by placing the matrix (3) on the plate (6). Then the die (1) is tightened to overcome the expansion force of the glue (4).

As shown in FIG. 3, the adhesive (4) expands in a time period that ranges from 10 to 15 minutes. Consequently, the expansion of the adhesive (4) makes the plate (6) bend inside the cavities (31, 31′) of the matrix (3). The expansion of the glue (4) must be such to fill the empty spaces defined by the cavities (31, 31′) of the matrix (3).

The die is then opened (1) and the multi-layer panel (100) composed of the base support (2), the layer of glue (4) and the shaped plate (6) is extracted.

As shown in FIG. 4, the plate (6) is suitably shaped according to the cavities (31, 31′) of the matrix. The plate (6) has two ribs (61, 61′) and respective grooves (62, 62′) in correspondence with the cavities (31, 31′) of the matrix.

In the following text, identical elements or elements that correspond to elements that have already been described are indicated with the same reference numerals, omitting their detailed description.

To obtain a shaped plate instead of a multilayer panel, a modification can be made to the forming process of the invention, as shown in FIGS. 5 and 6.

Anti-adherent material (8) is positioned between the layer of glue (4) and the plate (6) to prevent the glue (4) from adhering to the surface of the plate (6). The anti-adherent material (8) can be, for example, a sheet of plastic material, such as a polyethylene sheet, and also a paint or primer applied on the lower surface of the plate (6).

Advantageously, a second anti-adherent material (7) can be positioned between the base support (2) and the glue (4). In such a case, the base support (2) can be reused in the future processes and may directly consist in a plate of the forming press.

At the end of the forming process obtained from the expansion of the glue (4), a shaped plate (6) (shown in FIG. 7) is extracted from the die (1) together with a reject item (9) (shown in FIG. 8) consisting in solidified glue (4) positioned between the two films (7, 8).

Numerous variations and modifications can be made to the present embodiments of the invention by an expert of the field, while still falling within the scope of the invention as claimed in the enclosed claims.

1. Forming process of sheet materials, comprising the following phases:
application of a layer of glue (4) that expands in contact with air on a base support (2) of a die (1),
positioning of sheet material (6) on the layer of glue (4),
closing of the die (1) by means of a matrix (3) provided with at least one cavity (31, 31′), for a time sufficient for the glue (4) to expand, in such a way that the shape of the matrix (3) is formed on the sheet material (6), and
opening of the die, extraction of the formed part (100; 6).

2. Process as claimed in claim 1, characterised in that the glue (4) is a monocomponent polyurethane-base adhesive.

3. Process as claimed in claim 2, characterised in that the glue (4) has viscosity of approximately 70,000 cps and specific gravity of approximately 1.4 gr/m³.

4. Process as claimed in claim 2, characterised in that the glue (4) comprises tissotropic polyurethane obtained from reticulated polysocyanate resins.

5. Process as claimed in claim 1, characterised in that the glue (4) is applied with a spatula to obtain a uniform layer of glue.

6. Process as claimed in claim 1, characterised in that the layer of glue (4) applied on the base support (2) has thickness lower than 10 mm.

7. Process as claimed in claim 1, characterised in that water spray (5) is sprayed on the layer of glue (4) to accelerate the drying process of the glue.

8. Process as claimed in claim 1, characterised in that the die is maintained closed for approximately 10-15 minutes.

9. Process as claimed in claim 1, characterised in that the sheet material (8) is a metal plate.

10. Process as claimed in claim 1, characterised in that the base support (2) of the die has a flat surface (20) on which the layer of glue (4) is applied.

11. Process as claimed in claim 1, characterised in that a multilayer panel composed of the base support (2), the glue (4) and the shaped sheet material (6) is extracted from the die.

12. Process as claimed in claim 11, characterised in that the base support (2) is made of non-rigid material, such as leather, paper, fabric, unwoven fabric, plastic film and similar materials.

13. Process as claimed in claim 1, characterised in that it the process also comprises the interposition of an anti-adherent material (8) between the layer of glue (4) and the sheet material (6) to prevent the glue (4) from adhering to the sheet material (6) in such a way to extract the shaped sheet material (6) from the die.

14. Process as claimed in claim 1, characterised in that it the process also comprises the interposition of anti-adherent material (7) between the base support (2) and the layer of glue (4) to prevent the glue (4) from adhering to the base support (2).

15. Process as claimed in claim 13, characterised in that the anti-adherent material (7, 8) is composed of a plastic film.

16. Process as claimed in claim 14, characterised in that the base support (2) consists in a plate of a forming press.

17. Process as claimed in claim 14, characterized in that the anti-adherent material (7) is composed of a plastic film.
